(19) United States
(12) Patent Application Publication
(10) Pub. No.: US 2024/0227267 A1
(43) Pub. Date: Jul. 11, 2024

(54) Ultrasonic online nondestructive measurement method for melt density during molding

(71) Applicant: Zhejiang University, Hangzhou City (CN)

(72) Inventors: Peng Zhao, Hangzhou City (CN); Zhengyang Dong, Hangzhou City (CN); Kaipeng Ji, Hangzhou City (CN); Jianfeng Zhang, Hangzhou City (CN); Ruoxiang Gao, Hangzhou City (CN); Jianzhong Fu, Hangzhou City (CN)

(21) Appl. No.: 18/520,164

(22) Filed: Nov. 27, 2023

(30) Foreign Application Priority Data
Nov. 28, 2022 (CN) 202211500049.4

(51) Int. Cl. B29C 45/76; G01N 9/24

(52) U.S. Cl. CPC B29C 45/76; G01N 9/24; B29C 2945/76127; B29C 2945/76257; B29C 2945/76474

(57) ABSTRACT

The present disclosure discloses an ultrasonic online nondestructive measurement method for a melt density in injection molding, which solves the problems of difficult installation, high cost, influence on product surface quality, and the like existing in an existing density measurement method. According to the present disclosure, an ultrasonic velocity is obtained from a time domain signal with reference to time domain and frequency domain signal analysis of ultrasonic echo signals, an acoustic impedance is calculated by full spectrum analysis of a frequency domain signal, and the melt density is calculated from a correlation of the ultrasonic velocity, the acoustic impedance, and the density. The method has the advantages of having high measurement accuracy and being nondestructive, online and low in cost, and has a great application value in the injection molding industry.

### CROSS REFERENCE TO RELATED APPLICATION

This patent application claims the benefit and priority of Chinese Patent Application No. 202211500049.4, filed with the China National Intellectual Property Administration on Nov. 28, 2022, the disclosure of which is incorporated by reference herein in its entirety as part of the present application.

### TECHNICAL FIELD

The present disclosure relates to the technical field of detection methods, and in particular, to an ultrasonic online nondestructive measurement method for a melt density in injection molding.

### BACKGROUND

Polymers have been widely used in various industries in the world, and injection molding is one of the most important processes to convert polymer raw materials into products. With wide application of products formed by injection, requirements for high consistency and quality of products promotes development of online measurement methods during injection molding.

Product quality is largely determined by a polymer melt, and a melt density may be regarded as a quality index of the polymer melt. A change in density may lead to different refractive indexes. For example, a density of a peripheral region of a polymer lens product is greater than that of a central region thereof, which leads to a change in refractive index distribution. It can be seen that density measurement is an important factor to ensure quality in other aspects of the product.

A common density measurement method includes using a pycnometer, a densimeter or a density gradient column. A hydrometer and the densimeter are based on the Archimedes principle, which requires good fluid control and cannot handle a sample less than 50 mL. More importantly, the above methods can only measure the density of the product after demolding. The change in density may be used as a feedback of dynamic control within a production batch and between batches to ensure consistency of products. An offline measurement method may lead to a large time delay in process monitoring and optimization.

As mentioned above, online density measurement is very valuable for the injection molding process. It is necessary to mount sensors to obtain process information of in-situ measurement, and in-mold sensors have been widely used in injection molding process monitoring. A pressure-specific volume-temperature (PVT) method is the most commonly used method to calculate the density of the polymer melt, and the PVT characteristics of a polymer are basic properties of a material. A specific volume V of a specific polymer in any state always satisfies a certain correspondence with a pressure P and a temperature T of the specific polymer. In-mold temperature and pressure sensors are very important for the PVT method. However, the in-mold sensors have the following shortcomings in application: (1) The cost is high. The cost of a set of pressure and temperature sensors and a data acquisition device exceeds 100,000 yuan. (2) Mold modification is complicated. Based on technical requirements of an in-mold sensor assembly drawing, mounting holes usually have a complicated structure, and there are high requirements for accuracy (with a tolerance of H7). Therefore, the mold modification is complicated and time-consuming. (3) A surface of a product may be affected. Because the sensor has to be in direct contact with the melt, the sensor may leave traces on the surface of the product, which is unacceptable for a high-precision product, especially for a polymer lens and other optical components.

An ultrasonic measurement method has the advantages of being nondestructive and easy to mount, and has been applied to online measurement of the injection molding process. Existing ultrasonic measurement methods still have the following problems: (1) The measurement of the density of the polymer melt must compensate for the influence of temperature and viscosity to obtain an accurate result. (2) Due to internal drift of a circuit, aging of piezoelectric elements, the temperature of each part of a system, and other reasons, it is difficult to determine an amplitude of an incident wave. (3) Due to the existence of multilayer media, an echo signal is reflected and transmitted for many times, so that the sensitivity is reduced.

Based on the above considerations, it is necessary to propose an ultrasonic online nondestructive measurement method for a melt density in injection molding.

### SUMMARY

Against the problems existing in existing methods, the present disclosure provides an in-situ nondestructive measurement method for a melt density with reference to time domain and frequency domain analysis of ultrasonic signals for the first time. The proposed method does not need an in-mold sensor, which can avoid modification of a mold and ensure that a product surface is not affected.

To achieve the above objective, the present disclosure adopts the following technical solutions.

An ultrasonic online nondestructive measurement method for a melt density in injection molding includes the following steps:
(1) mounting an ultrasonic probe on an outer side wall of a mold cavity, and emitting an ultrasonic wave toward a polymer melt in the mold cavity;
(2) collecting reflection echoes of two surfaces of the melt in contact with a mold, where the reflection echo of the surface close to the probe is denoted as U₁, and the other reflection echo is denoted as U₂;
(3) calculating an ultrasonic propagation velocity in the polymer melt based on time domain signals of the reflection echoes U₁ and U₂; calculating an acoustic impedance of the polymer melt based on frequency domain signal amplitude spectra of the reflection echo U₁ and U₂; and
(4) calculating the melt density based on ρ=Z/c and the calculated ultrasonic propagation velocity and acoustic impedance, where Z is the acoustic impedance of the polymer melt, and c is the ultrasonic propagation velocity in the polymer melt.

A method for calculating the ultrasonic propagation velocity c is:

$$c = \frac{2 h}{Δ t} ,$$

where h is a thickness of the melt in an ultrasonic propagation direction, and Δt is a time difference between the reflection echoes U₁ and U₂, and may be calculated by using a cross-correlation method:

Rᵤ_{₁}ᵤ_{₂}(τ)=∫₀^{t}^{ₜₒₜₐₗ}u₁(t)u₂(t+τ)dt

Rᵤ_{₁}ᵤ_{₂}(Δt)=max(Rᵤ_{₁}ᵤ_{₂}(τ),

where τ is a time delay, Rᵤ_{₁}ᵤ_{₂}(τ) represents a correlation function of u₁ and u₁; tₜₒₜₐₗ is a total time of echo signals; u₁(t) is a reflection echo signal from a first surface of the polymer melt; u₂(t+τ) is a reflection echo signal from a second surface of the polymer melt; and Rᵤ_{₁}ᵤ_{₂}(Δt) is a delay τ corresponding to a peak value of the correlation function, that is, an ultrasonic propagation time Δt.

In step (4), a transfer function of the ultrasonic echo signals may be expressed as a ratio of frequency domain signal amplitude spectra:

H(ω)=U₂(ω)/U₁(ω),

where U(ω) is a frequency domain amplitude spectrum of an echo signal, and is obtained from a time domain signal u(t) by fast Fourier transform:

U(ω)=∫_{-∞}^{+∞}u(t)e^{-iωt}dt.

Based on the law of ultrasonic propagation, the transfer function H(ω) may be calculated by using the following formula:

H(ω)=K·exp(−2mhα(ω/ω_{c})ⁿ−j(ϕ₁(ω)−ϕ₂(ω))),

where K is an ultrasonic propagation proportionality coefficient, h is a thickness of the melt in the ultrasonic propagation direction, ω_{c} is a center frequency of the ultrasonic probe, α represents an attenuation coefficient, m is a proportionality coefficient of a unit of the attenuation coefficient converted from (Np/cm) to (dB/cm), and for the coefficient n=1 of most polymer materials, a function of a frequency ω may be obtained by calculating a logarithm on both sides of the formula:

$$\begin{matrix}ln ( \vert H ( ω ) \vert ) & = ln ( K ) - 2 mh α ( ω / {ω}_{c} ) \\ & = b + K ω\end{matrix} ,$$

where b=ln(K) may be regarded as an intercept, and K=e^{b}. The intercept may be obtained by linear fitting of data. Through fitting by using the above formula, the ultrasonic propagation proportionality coefficient K may be obtained.

Preferably, the acoustic impedance of the polymer melt is obtained by solving an ultrasonic propagation proportionality coefficient, an acoustic impedance coefficient of a back mold material, and an acoustic impedance coefficient of a front mold material.

Further, preferably, based on the law of ultrasonic reflection and transmission, the coefficient K is calculated b using the following formula:

$$K = \frac{{R}_{1} {T}_{0} {T}_{0}^{′}}{{R}_{0}} = \vert \frac{4 {Z}_{0} {Z}_{1} ( {Z}_{2} - {Z}_{1} )}{( {Z}_{1} + {Z}_{2} ) ( {Z}_{1}^{2} - {Z}_{0}^{2} )} \vert ,$$

where ∥ is an operation of solving an absolute value; R₀ and R₁ are reflection coefficients of a front surface and a rear surface of the melt in contact with a mold material, respectively, T₀ and T₀′ are transmission coefficients of ultrasonic signals propagating forward and backward through the front surface of the melt in contact with the mold respectively, and Z₀, Z₁ and Z₂ are sequentially acoustic impedance coefficients of the back mold material, a melt material and the front mold material in the ultrasonic propagation direction, where Z₀ and Z₂ are known. The acoustic impedance Z=Z₁ of the polymer melt may be obtained by solving the following formula. When K, Z₀ and Z₂ are known, a cubic equation with one unknown about the acoustic impedance Z₁ of the melt can be seen from the above formula, and the acoustic impedance may be calculated by solving the equation.

Preferably, the ultrasonic probe is arranged perpendicular to a flow direction of the polymer melt, and a side of the polymer melt receiving an ultrasonic signal has a plane structure perpendicular to the ultrasonic signal.

The method according to the present disclosure can be used for online measurement of densities of melts made of various polymer materials by injection molding.

The ultrasonic online nondestructive measurement method for a melt density in injection molding according to the present disclosure has the following beneficial effects.
1. The present disclosure provides an online nondestructive measurement method for a density, which does not need to mount an in-mold sensor, uses an ultrasonic time domain and frequency domain signal analysis method to obtain the density of the melt, and has the advantages of being easy to mount and having no influence on a surface of a product.
2. The method according to the present disclosure features high accuracy, and can adapt to different process conditions, materials and mold cavity structures.
3. In addition, the online measurement method for a melt density according to the present disclosure may be used as a general method of density measurement in the injection molding industry. In the future, research will be performed to improve measurement accuracy, and the proposed method will be applied to online process monitoring and optimization of injection molding.

### BRIEF DESCRIPTION OF THE DRAWINGS

FIG. 1 is a flowchart of an ultrasonic online nondestructive measurement method for a melt density in injection molding according to the present disclosure;

FIG. 2 is a schematic diagram of an echo formed by an ultrasonic wave passing through a polymer melt in a measurement method according to the present disclosure;

FIGS. 3A-B show time domain signal of an ultrasonic echo in an embodiment, and FIGS. 3C-D show frequency domain signal of the ultrasonic echo;

FIG. 4A shows an ultrasonic velocity calculated by analyzing an ultrasonic time domain signal in an embodiment; FIG. 4B shows a process of linear fitting calculation of an ultrasonic frequency domain signal in the embodiment;

FIG. 5 shows measurement results of an ultrasonic velocity, an acoustic impedance and a density in an embodiment, and a comparison with a PVT method; and

FIG. 6 shows measurement results in the case of different materials and a comparison with a PVT method.

### DETAILED DESCRIPTION OF THE EMBODIMENTS

The present disclosure is described in detail below with reference to a flowchart of the present disclosure. An ultrasonic online nondestructive measurement method for a melt density in injection molding according to the present disclosure is combined with of time domain and frequency domain signal analysis. An ultrasonic propagation velocity is calculated from time domain signal analysis, an acoustic impedance of the melt is calculated by full spectrum analysis of a frequency domain signal, and the melt density is calculated from a correlation of the ultrasonic velocity, the acoustic impedance, and the density.

The present disclosure is described in detail below with reference to the embodiments.

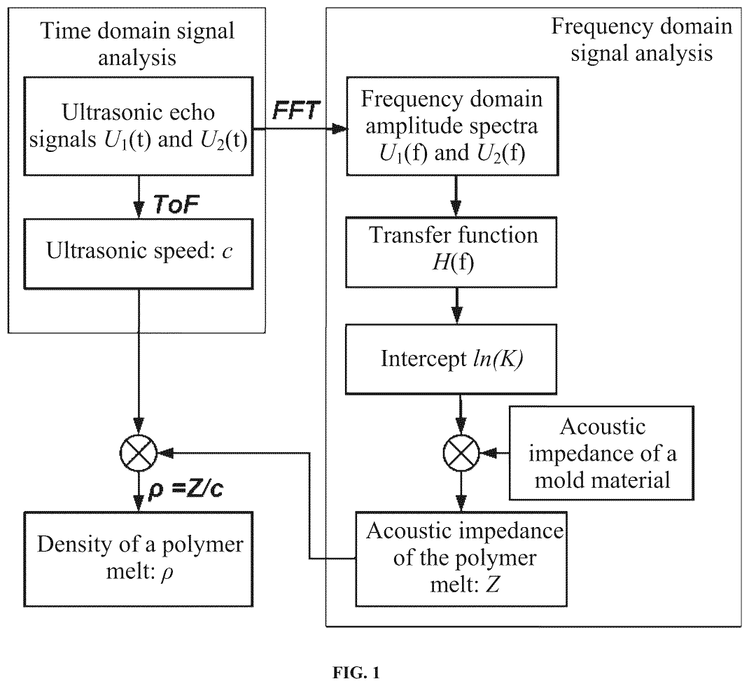

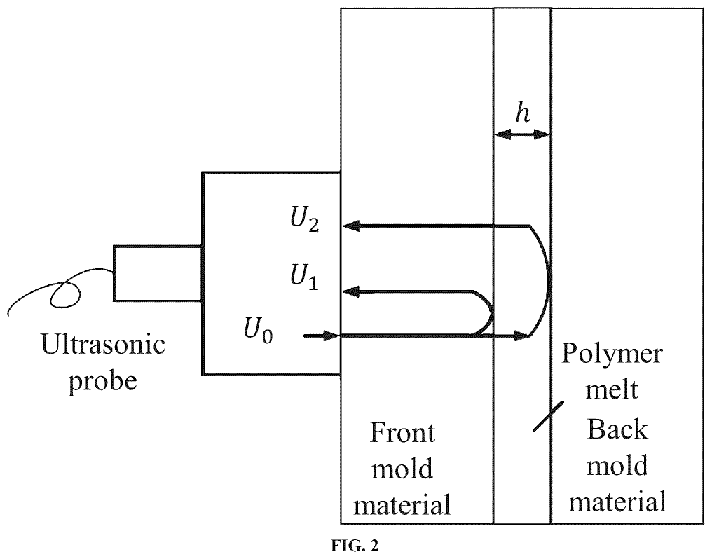

As shown in FIG. 1, an ultrasonic online nondestructive measurement method for a melt density in injection molding includes the following steps.
(1): Mount an ultrasonic probe on an outer side wall of a mold cavity, and emit an ultrasonic wave toward a polymer melt in the mold cavity, where an initial ultrasonic signal is denoted as U₀.
(2): Collect reflection echoes of two surfaces of the melt in contact with a mold, where the reflection echo of the surface close to the probe is denoted as U₁, and the other reflection echo is denoted as U₂, as shown in FIG. 2.
(3); Calculate an ultrasonic propagation velocity in the polymer melt by using a transit time method based on time domain signals of the reflection echoes U₁ and U₂, where a method for calculating the ultrasonic propagation velocity c is as follows:

$$c = \frac{2 h}{Δ t} ,$$

where h is a thickness of the melt in an ultrasonic propagation direction, and Δt is a time difference between the reflection echoes U₁ and U₂, and may be calculated by using a cross-correlation method:

Rᵤ_{₁}ᵤ_{₂}(τ)=∫₀^{t}^{ₜₒₜₐₗ}u₁(t)u₂(t+τ)dt

Rᵤ_{₁}ᵤ_{₂}(Δt)=max(Rᵤ_{₁}ᵤ_{₂}(τ),

where τ is a time delay, and tₜₒₜₐₗ is a total time of echo signals.
(4): Calculate an acoustic impedance of the polymer melt based on frequency domain signal amplitude spectra of the reflection echo U₁ and U₂, where a calculation process is as follows:

A transfer function of ultrasonic echo signals may be expressed as a ratio of frequency domain signal amplitude spectra:

H(ω)=U₂(ω)/U₁(ω),

where U(ω) is a frequency domain amplitude spectrum of an echo signal, and is obtained from a time domain signal u(t) by fast Fourier transform:

U(ω)=∫_{-∞}^{+∞}u(t)e^{-iωt}dt.

U₁(ω) and U₂(ω) may be obtained by using the above; and then H(ω) is obtained.

Based on the law of ultrasonic propagation, the transfer function H(ω) may be calculated by using the following formula:

H(ω)=K·exp(−2mhα(ω/ω_{c})ⁿ−j(ϕ₁(ω)−ϕ₂(ω))),

where h is a thickness of the melt in the ultrasonic propagation direction, ω_{c} is a center frequency of the ultrasonic probe, α represents an attenuation coefficient, and for the coefficients n=1 of most polymer materials, a function of a frequency ω may be obtained by calculating a logarithm on both sides of the formula:

$$\begin{matrix}ln ( \vert H ( ω ) \vert ) & = ln ( K ) - 2 mh α ( ω / {ω}_{c} ) \\ & = b + K ω\end{matrix} ,$$

where b=ln(K) may be regarded as an intercept, and a proportionality coefficient K=e^{b} may be regarded as a slope. The intercept and the slope may be obtained by linear fitting of data.

Based on the law of ultrasonic reflection and transmission, the coefficient K is calculated by using the following formula:

$$K = \frac{{R}_{1} {T}_{0} {T}_{0}^{′}}{{R}_{0}} = \vert \frac{4 {Z}_{0} {Z}_{1} ( {Z}_{2} - {Z}_{1} )}{( {Z}_{1} + {Z}_{2} ) ( {Z}_{1}^{2} - {Z}_{0}^{2} )} \vert ,$$

where R₀ and R₁ are reflection coefficients of a front surface and a rear surface of the melt in contact with a mold material, respectively, T₀ and T₀′ are transmission coefficients of ultrasonic signals propagating forward and backward through the front surface of the melt in contact with the mold respectively, and Z₀, Z₁ and Z₂ are sequentially acoustic impedance coefficients of the back mold material, a melt material and the front mold material in the ultrasonic propagation direction, where Z₀ and Z₂ are known.

When K, Z₀ and Z₂ are known, a cubic equation with one unknown about the acoustic impedance Z₁ of the melt can be seen from the above formula, and the acoustic impedance may be calculated by solving the equation.
(5): Calculate the melt density based on ρ=Z/c and the calculated propagation velocity and acoustic impedance, where Z is the acoustic impedance of the polymer melt, and c is the ultrasonic propagation velocity in the polymer melt, which are obtained in steps (4) and (3), respectively.

The present disclosure is described in detail below with reference to the embodiments.

### Embodiment

A specific implementation of the present disclosure is described with ultrasonic measurement of a melt density of a self-made slit rheological mold as an example. An injection molding machine used in this embodiment was China ONGO Z70JD, an ONGO model. A measuring system is composed of an ultrasonic measuring apparatus and a pressure-temperature measuring apparatus (so that a PVT method is used to measure the density for verification). An ultrasonic signal transmitter/receiver (CTS-8077PR, SIUI, China) is configured to transmit a signal to an ultrasonic probe (5P20, Doppler, China) and receive an ultrasonic echo passing through a polymer melt. The ultrasonic probe is mounted on a back of a mold core. A digital oscilloscope (DSOX-3014 T Keysight Technologies, USA) is configured to display and record received data for further signal processing and analysis. A pressure sensor (SPF04, Futaba, Japan) and an infrared temperature sensor (EPSSZT, Futaba, Japan) are mounted in a mold cavity, and pressure and temperature data is collected by a data acquisition card (MVS08, Futaba, Japan) and displayed on a computer.

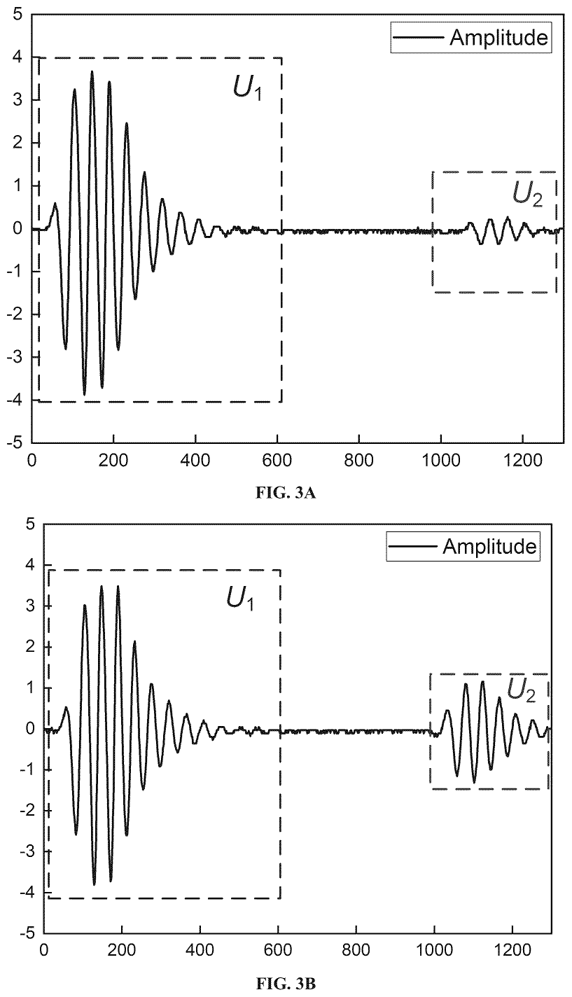

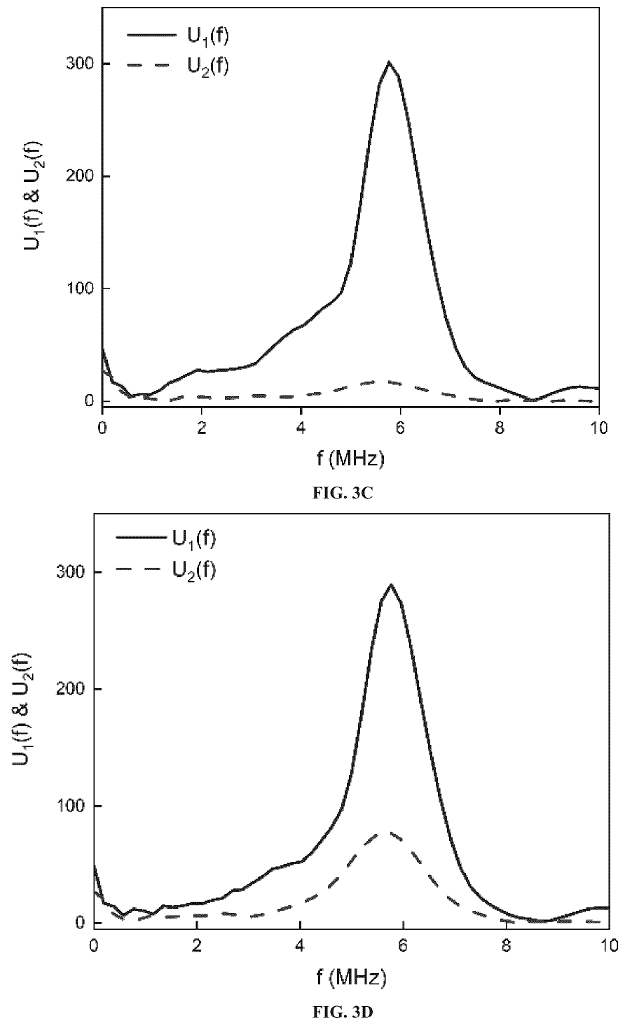

First, an experiment was performed by using a low density polyethylene (LDPE) material, with a total data acquisition time of 4.5 seconds. There were a total of 450 sampling points. Ultrasonic echo signals at a beginning time (0.3 s, left figure) and ultrasonic echo signals at an intermediate time (1.7 s, right figure) of the forming process are shown in FIGS. 3A-D, including time domain signals in FIGS. 3A-B and frequency domain signals in FIGS. 3C-D. It should be noted that an amplitude of an echo signal U₂ increased gradually, indicating that the mold cavity was gradually filled with the polymer melt.

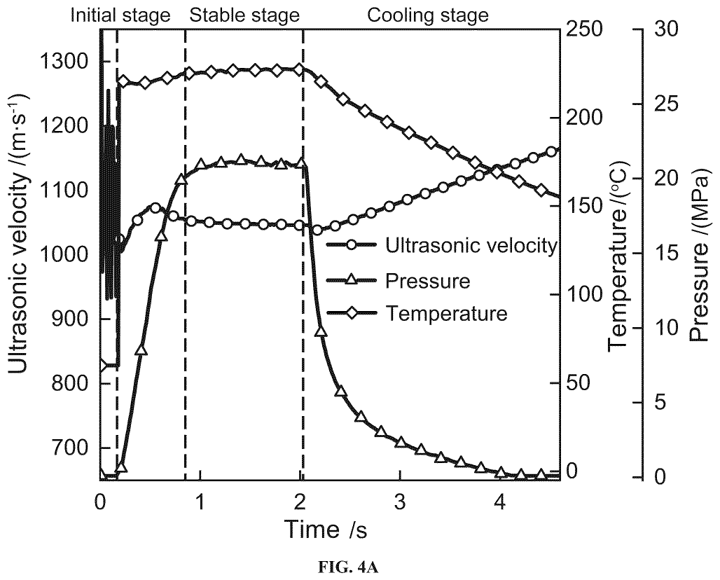

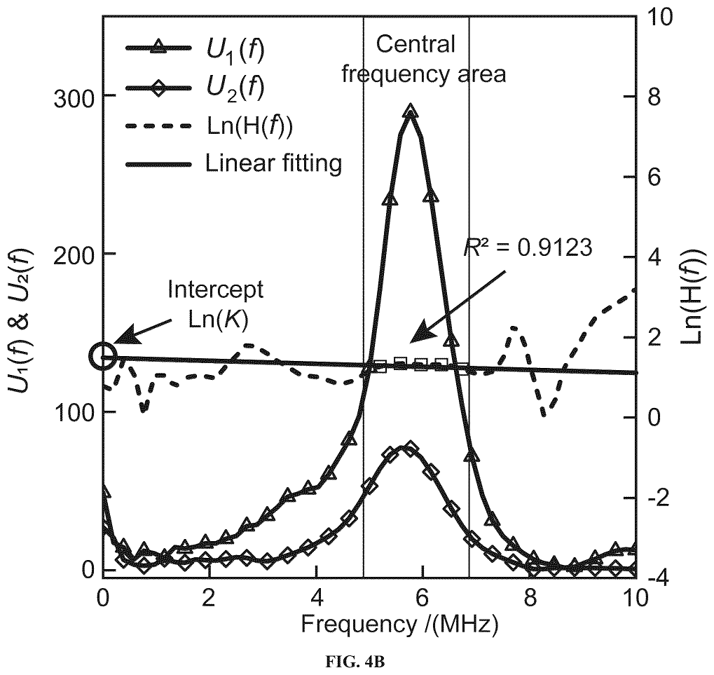

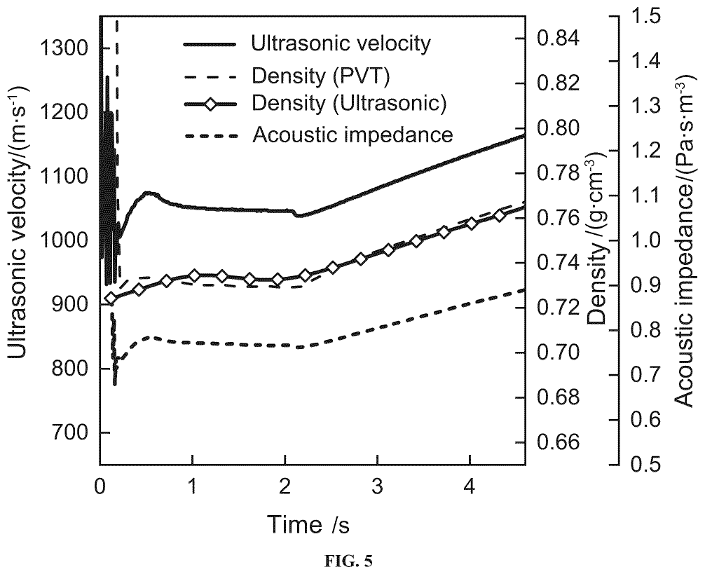

Curves of a calculated ultrasonic velocity and a measured temperature and pressure in the entire process are shown in FIGS. 4A-B. It can be seen that there is a close correlation between the ultrasonic velocity and the temperature and the pressure, which means that ultrasonic signals can reflect different stages in the injection molding process. A logarithm of a fast Fourier transform (FFT) amplitude spectrum and a transfer function is shown in FIG. 4B. A logarithm near a center frequency of the probe has stronger linearity (R²=0.9123). Therefore, points in this range are used for linear fitting and for obtaining an intercept. An intercept (ln(K)) at each sampling time was collected in the entire forming period, and then an acoustic impedance was calculated, as shown by the green dashed line in FIG. 5. Online measurement results of a change in density were calculated by using the ultrasonic propagation velocity and the acoustic impedance. A comparison between a density measurement (an ultrasonic method) and a reference value (a PVT method) is shown by red and blue solid lines in FIG. 5. A root mean square error (RMSE) was 0.0245 g/cm³, and a maximum relative error was 6.48%, indicating that this method can accurately measure the melt density.

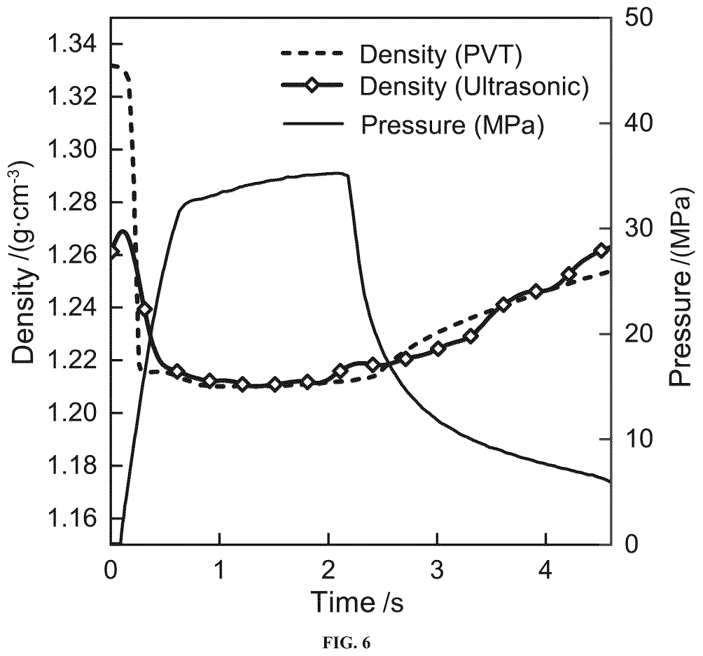

An experiment using a polyvinyl chloride (PVC) material was also performed to test effectiveness of the proposed method in the case of using different materials. Density measurement results are shown in FIG. 6. Compared with an LDPE material, the PVC material has a similar density change process, but has an overall density greater than that of the LDPE. The density measurement RMSE of the PVC material was 0.01409 g/cm³ with a maximum relative error of 5.59%, which is similar to that of the LDPE. The implementation of the proposed ultrasonic method does not need to involve material characteristic parameters, and thus the method can be applied to density measurement of different materials. Therefore, the proposed ultrasonic method can be applied to other types of polymer materials.

1. An ultrasonic online nondestructive measurement method for a melt density in injection molding, comprising the following steps:
(1) mounting an ultrasonic probe on an outer side wall of a mold cavity, and emitting an ultrasonic wave toward a polymer melt in the mold cavity;
(2) collecting reflection echoes of two surfaces of the melt in contact with a mold, wherein the reflection echo of the surface close to the probe is denoted as U₁, and the other reflection echo is denoted as U₂;
(3) calculating an ultrasonic propagation velocity in the polymer melt based on time domain signals of the reflection echoes U₁ and U₂; calculating an acoustic impedance of the polymer melt based on frequency domain signal amplitude spectra of the reflection echo U₁ and U₂; and
(4) calculating the melt density based on ρ=Z/c and the calculated ultrasonic propagation velocity and acoustic impedance, wherein Z is the acoustic impedance of the polymer melt, and c is the ultrasonic propagation velocity in the polymer melt.

2. The ultrasonic online nondestructive measurement method for a melt density in injection molding according to claim 1, wherein a method for calculating the ultrasonic propagation velocity c is:
$$c = \frac{2 h}{Δ t} ,$$
wherein h is a thickness of the polymer melt in an ultrasonic propagation direction, and Δt is a time difference between the reflection echoes U₁ and U₂, and is calculated by using a cross-correlation method from the time domain signals of the reflection echoes U₁ and U₂.

3. The ultrasonic online nondestructive measurement method for a melt density in injection molding according to claim 1, wherein the acoustic impedance of the polymer melt is obtained by solving an ultrasonic propagation proportionality coefficient, an acoustic impedance coefficient of a back mold material, and an acoustic impedance coefficient of a front mold material.

4. The ultrasonic online nondestructive measurement method for a melt density in injection molding according to claim 3, wherein the acoustic impedance Z=Z₁ of the polymer melt is obtained by solving the following formula:
$$K = \vert \frac{4 {Z}_{0} {Z}_{1} ( {Z}_{2} - {Z}_{1} )}{( {Z}_{1} + {Z}_{2} ) ( {Z}_{1}^{2} - {Z}_{0}^{2} )} \vert ,$$
wherein ∥ is an operation of solving an absolute value; K is the ultrasonic propagation proportionality coefficient; and Z₀, Z₁ and Z₂ are sequentially acoustic impedance coefficients of the back mold material, a melt material and the front mold material in the ultrasonic propagation direction.

5. The ultrasonic online nondestructive measurement method for a melt density in injection molding according to claim 1, wherein the ultrasonic propagation proportionality coefficient is obtained by fitting a relationship between a transfer function and a frequency ω of ultrasonic echo signals.

6. The ultrasonic online nondestructive measurement method for a melt density in injection molding according to claim 5, wherein the relationship is as follows:
ln(|H(ω)|)=ln(K)−2mhα(ω/ω_{c}),
wherein H(ω) is the transfer function of the ultrasonic echo signals; K is the ultrasonic propagation proportionality coefficient; m is a proportionality coefficient of a unit of an attenuation coefficient converted from (Np/cm) to (dB/cm); h is a thickness of the melt in the ultrasonic propagation direction, ω_{c} is a center frequency of the ultrasonic probe, and α represents the attenuation coefficient.

7. The ultrasonic online nondestructive measurement method for a melt density in injection molding according to claim 1, wherein the ultrasonic probe is arranged perpendicular to a flow direction of the polymer melt, and a side of the polymer melt receiving an ultrasonic signal has a plane structure perpendicular to the ultrasonic signal.

8. The ultrasonic online nondestructive measurement method for a melt density in injection molding according to claim 3, wherein the ultrasonic propagation proportionality coefficient is obtained by fitting a relationship between a transfer function and a frequency ω of ultrasonic echo signals.

9. The ultrasonic online nondestructive measurement method for a melt density in injection molding according to claim 8, wherein the relationship is as follows:
ln(|H(ω)|)=ln(K)−2mhα(ω/ω_{c}),
wherein H(ω) is the transfer function of the ultrasonic echo signals; K is the ultrasonic propagation proportionality coefficient; m is a proportionality coefficient of a unit of an attenuation coefficient converted from (Np/cm) to (dB/cm); h is a thickness of the melt in the ultrasonic propagation direction, ω_{c} is a center frequency of the ultrasonic probe, and α represents the attenuation coefficient.
